(19) United States
(12) Patent Application Publication
(10) Pub. No.: US 2015/0019284 A1
(43) Pub. Date: Jan. 15, 2015

(54) DYNAMICALLY MODIFYING BUSINESS PROCESSES BASED ON REAL-TIME EVENTS

(71) Applicants: HUNG TACK KWAN, GRAND PRAIRIE, TX (US); SHIJU MATHAI, CARROLLTON, TX (US)

(72) Inventors: HUNG TACK KWAN, GRAND PRAIRIE, TX (US); SHIJU MATHAI, CARROLLTON, TX (US)

(73) Assignee: INTERNATIONAL BUSINESS MACHINES CORPORATION, ARMONK, NY (US)

(21) Appl. No.: 13/937,263

(22) Filed: Jul. 9, 2013

(51) Int. Cl. G06Q 10/06

(52) U.S. Cl. CPC G06Q 10/06316
USPC 705/7.26

(57) ABSTRACT

An event within an external or an internal environment can be detected. The environments can be computing environments within a computing device. Real-time analytics can be performed to determine event specifics which can be a state and/or a state data. A published category associated with the event can be determined based on the real analytics performed on the event associated with the event. A category and the specifics can be published to a subscription registry. A subscription message can be conveyed to a business process instance subscribed to the category responsive to the publishing. The instance can be associated with a business process and can include an activity and/or a process which can be interrupted during execution of an activity. The activity can lack fault handling activity capabilities. A change to perform on the instance can be identified. The instance can be automatically reconfigured based on the change.

### BACKGROUND

The present invention relates to the field of business process management and, more particularly, to dynamically modifying business processes based on real-time events.

Business processes are the essence of every enterprise objectives and success. The importance of process can be demonstrated by the many software categories that have emerged to support processes, including: process modeling, business process re-engineering, workflows, and project management. Traditional business activities, such as those in the insurance and banking industries, were the initial targets for computational support. These business processes can be ideal candidates for automation as they involve moving large numbers of “cases” through the activities of relatively stable processes. The software tools that were developed for business processes handle the movement of cases in much the same way as material handling can be managed in manufacturing processes. For example, analytical process-modeling software is used to engineer an efficient “steady-state” case flow, and then workflow software is used to implement the engineered process.

The current business process (BP) design paradigm can be static and consequently processes cannot be rapidly adjusted/modified in response to new information from real-time analytics. Current dynamic business process handling often requires human input to permit business processes to be dynamically modified. For example, an analyst is required to know and/or identify all possible event interruption points and define them in the business process. That is, business process modification can be too rigidly defined and can require significant re-engineering to perform changes where interruption points are not defined.

### BRIEF SUMMARY

One aspect of the present invention can include a system, an apparatus, a computer program product, and a method for dynamically modifying business processes based on real-time events. An event within an external or an internal environment can be detected. The environments can be computing environments within a computing device. Real-time analytics can be performed to determine event specifics which can be a state and/or a state data. A published category associated with the event can be determined based on the real analytics performed on the event associated with the event. A category and the specifics can be published to a subscription registry. A subscription message can be conveyed to a business process instance subscribed to the category responsive to the publishing. The instance can be associated with a business process and can include an activity and/or a process which can be interrupted during execution of an activity. The activity can lack fault handling activity capabilities. A change to perform on the instance can be identified. The instance can be automatically reconfigured based on the change.

Another aspect of the present invention can include an apparatus, a computer program product, a method, and a system for dynamically modifying business processes based on real-time events. A business process engine can be able to dynamically reconfigure a business process instance of a business process responsive to an event occurring within a computing environment. The instance can be associated with a business process. The instance can include an activity and/or a process. The business process instance can be a business process execution language (BPEL) entity. A data store can be configured to persist at least one of a reconfiguration mapping, an event data, and a context data.

### BRIEF DESCRIPTION OF THE SEVERAL VIEWS OF THE DRAWINGS

FIG. 1 is a schematic diagram illustrating a flow for dynamically modifying business processes based on real-time events in accordance with an embodiment of the inventive arrangements disclosed herein.

FIG. 2 is a schematic diagram illustrating a method for dynamically modifying business processes based on real-time events in accordance with an embodiment of the inventive arrangements disclosed herein.

FIG. 3 is a schematic diagram illustrating a system for dynamically modifying business processes based on real-time events in accordance with an embodiment of the inventive arrangements disclosed herein.

FIG. 4 is a schematic diagram illustrating a set of embodiments for dynamically modifying business processes based on real-time events in accordance with an embodiment of the inventive arrangements disclosed herein.

### DETAILED DESCRIPTION

The present disclosure is a solution for dynamically modifying business processes based on real-time events. In the solution, a publish/subscribe functionality can be employed to dynamically modify business process instances. A business process instance can subscribe to an event topic within a subscription registry. An event within an internal/external environment can be detected. Real-time analytics of the event can be utilized to determine event topics which can be associated with the event. When an event topic matches a business process registration, the process instance associated with the subscription can be dynamically modified based on the analytics. Modifications can include, activity addition, activity removal, and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

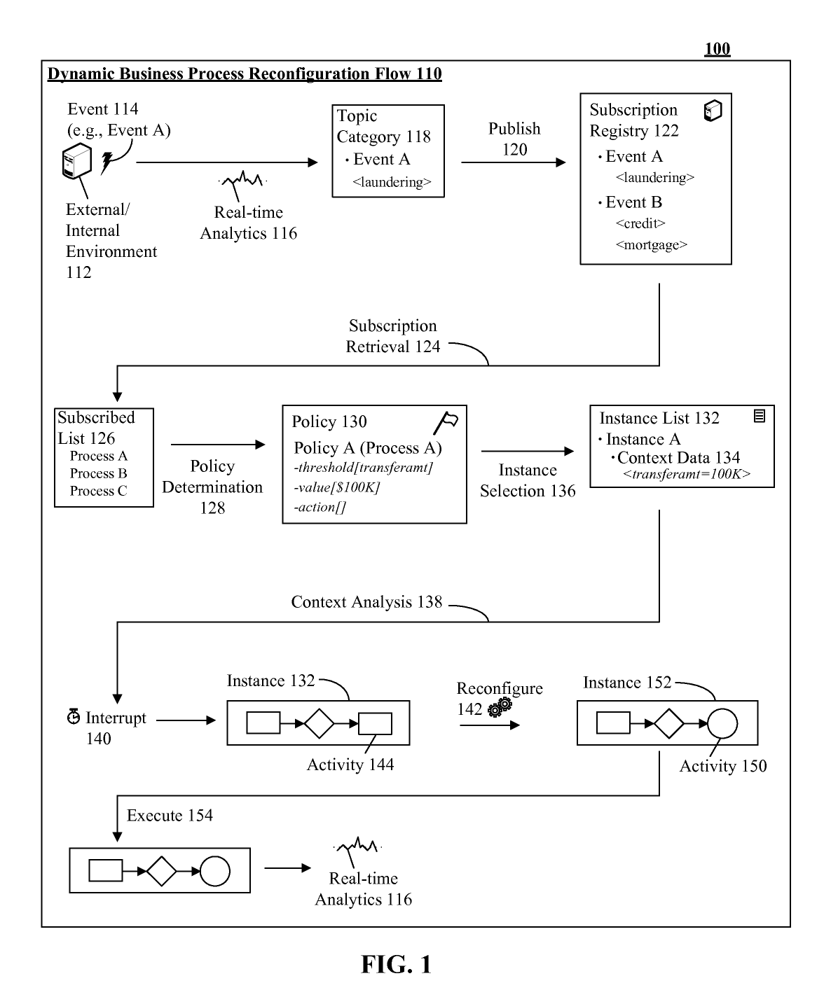

FIG. 1 is a schematic diagram illustrating a flow 110 for dynamically modifying business processes based on real-time events in accordance with an embodiment of the inventive arrangements disclosed herein. Flow 110 can be performed in the context of method 200, system 300 and/or embodiments 410, 430, 450. In flow 110, an event 114 can trigger a dynamic modification of a process instance (e.g., instance 132). For example, when a non-authorized transaction is detected within a database, the disclosure can dynamically reconfigure a non-authorized detection process to detect subsequent non-authorized transactions. Flow 110 can continuously execute during a business process execution. For example, flow 110 can be associated with one or more instances of a business process, permitting the instances to dynamically change during the process lifespan.

In flow 110, an event 114 can be detected within an external and/or internal environment 112. For example, event 114 can be a business event occurring in remote computing system communicatively linked to a business process engine. In one instance, event 114 can be an occurrence within a real world. For example, event 114 can be a manual event associated with a human agent. For example, event 114 can be a user login action within a banking Web site. Event 114 can include, but is not limited to, input events, output events, messaging events, and the like. For example, event 114 can be a messaging notification from a publish/subscribe system. Event 114 can be detected utilizing traditional and/or proprietary mechanisms. For example, event 114 can be detected via one or more database triggers. In one embodiment, event 114 can be manually detected.

Event 114 can be subjected to one or more real-time analytics 116 to determine event 114 details. For example, analytics 116 can determine the time of the event 114 occurrence and entities affected by the event 114. Analytics 116 can include, but is not limited to, enterprise decision analytics, Web analytics, risk analytics, non-authorized analytics, and the like. In one instance, analytics 116 can extract data from event 114 to determine a topic category 118. In the instance, category 118 can be a logical channel associated with a publish/subscribe system. For example, analytics 116 can be a real-time business intelligence analytics determining one or more keywords (e.g., laundering) associated with event. In one embodiment, analytics 116 can be performed on an IBM E-FORM to determine relevant data associated with the event 114. For example, analytics 116 can include Extensible Markup Language data extraction capabilities.

In one embodiment, category 118 can be published to a subscription registry 122. In the embodiment, category 118 data be conveyed to registry 122 via publish 120 action. In one instance, the disclosure can utilize an existing registry and/or can establish a registry for performing the functionality described herein. In the instance, registry selection can be manually and/or automatically performed. It should be appreciated that when category 118 exists within a registry, event 114 data can be appropriately added to the registry 122. Registry 122 can conform to a traditional and/or proprietary subscription manager software, a subscription registry software, and the like. In one instance, publish 120 action can trigger a subscribed list 126 to be created for the category 118. In the instance, list 126 can be one or more business process subscribed to the category 118. It should be appreciated that business processes and/or instances 132, 152 can be manually and/or automatically subscribed to one or more categories 118. Processes and/or instances 132, 152 can be subscribed during creation, during runtime, and the like. It should be appreciated that subscription can include traditional (e.g., queue name, topic) and/or proprietary data.

In one embodiment, a business process can be selected from the list 126 and a policy 130 associated with the process can be determined. For example, a policy determination 128 action can query a business process engine to establish one or more policies (e.g., policy A) linked to the process A. It should be appreciated that policy determination 128 can conform to traditional and/or proprietary policy retrieval/parsing actions. In one embodiment, a process instance list 132 can be can be generated. In the embodiment, list 132 can include instances (e.g., Instance A) of a process (e.g., Process A).

In one instance, an instance within list 132 can be selected and a context analysis 138 can be performed. In the instance, context analysis 138 can analyze context data 134 associated with the instance. In one embodiment, when context data 134 matches event 114 data, the disclosure can perform an interrupt 140 action. In the embodiment, interrupt 140 can stop process instance 132 from executing. It should be noted that interrupt 140 can occur during an instance activity (e.g., activity 144) which lacks an exception handling capability. That is, the disclosure can dynamically interrupt an instance. It should be appreciated that interrupt 140 can suspend, stop, and/or restart the instance. In one instance, the disclosure can leverage an existing interruption point to interrupt the process instance appropriately. If interrupt 140 fails, a notification to an appropriate entity can be conveyed. For example, if interrupt 140 fails to execute successfully, an email can be conveyed to the owner of the process and/or an associated business process analyst user.

Reconfigure 142 action can be performed upon the successful completion of interrupt 140. Reconfigure 142 can alter the instance to appropriately accommodate for event 114 subsequent occurrence. Reconfigure 142 can include optimization actions, error handling actions, and the like. For example, instance 132 can include an activity 144 which can be replaced with an activity 150 enabling instance 152 to detect event 114.

In one embodiment, instance 132 can be reconfigured utilizing resources one or more configuration pools. In the embodiment, resources within pools can include, but is not limited to, an activity, sub-processes, configuration settings, and the like. In one configuration of the embodiment, resources within the configuration pools can be manually and/or automatically defined. In one instance, resources can include resource identifiers, resource capabilities, resource limitations, and the like. For example, a resource within a configuration pool can be tagged with a “login validation” keyword, indicating the resource can be utilized to reconfigure an instance requiring a login validation action. It should be appreciated that the disclosure is not limited to configuration pools.

It should be understood that the disclosure can leverage traditional and/or proprietary reconfiguration actions to be performed prior, during, and/or after reconfigure 142. It should be appreciated that reconfigure 142 can include manual and automated procedures. For example, reconfigure 142 can be subject to a user review which can require user approval before the reconfiguration is committed.

The instance 152 can be executed utilizing policy 130 information. The instance 152 can be analyzed by real-time analytics which can be utilized to subsequently reconfigure instance 152 via flow 110.

Drawings presented herein are for illustrative purposes only and should not be construed to limit the invention in any regard. It should be appreciated that flow 110 can include one or more optional steps which can be omitted permitting the functionality of the disclosure is retained. It should be appreciated that business process and/or instances 132, 152 can conform to a Business Process Execution Language (BPEL), a Web Services BPEL (WS-BPEL), and the like. It should be understood that a business process and/or instance 132, 152 can be associated with a workflow. In one embodiment, the disclosure can be associated with XFORMS data processing model. In the embodiment, XFORMS can include IBM LOTUS FORMS, FORMFACES, AJAXFORMS, XSLTFORMS, and the like. It should be appreciated that one or more user notifications can be conveyed during flow 110 in response to actions and/or outcomes of actions. User notifications can include electronic mail notifications, Short Message Service (SMS) notifications, text exchange notifications, voice notifications, and the like.

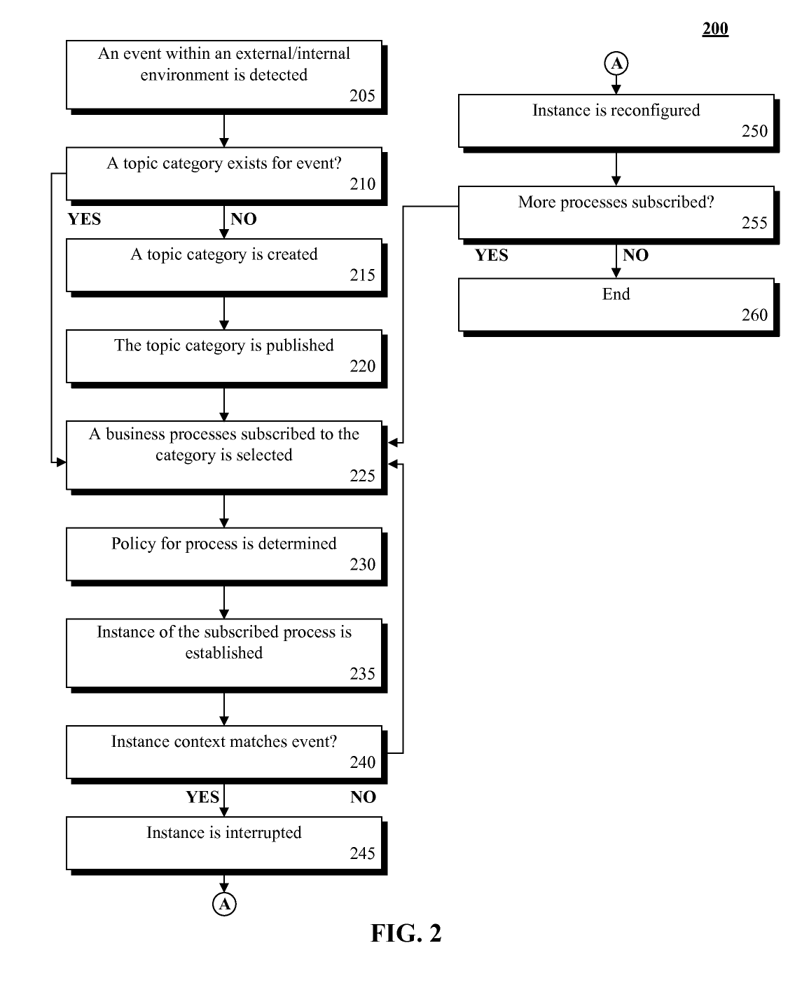

FIG. 2 is a schematic diagram illustrating a method 200 for dynamically modifying business processes based on real-time events in accordance with an embodiment of the inventive arrangements disclosed herein. Method 200 be performed in the context of flow 110, system 300, and/or embodiments 410, 430, 450. Method 200 can be performed in serial and/or in parallel. In method 200, an event can trigger a process instance reconfiguration within a business process environment.

In step 205, an event within an external and/or internal environment can be detected. In one instance, the event can conform to an event definition language (EDL) format. In step 210, if a topic category exists for the event, the method can continue to step 225, else proceed to step 215. In step 215, a topic category can be created. In step 220, the topic category can be published. In step 225, a business process subscribed to the category can be selected. In step 230, a policy for the process can be determined. In step 235, instances of the subscribed process can be established. In step 240, if an instance context matches the event 240, the method can continue to step 245, else return to step 225. In step 245, the process can be interrupted. In step 250, the process can be reconfigured. It should be appreciated that step 235-250 can be repeated for each instance associated with the process. In step 255, if there are more subscribed processes, the method can return to step 225, else continue to step 260. In step 260, the method can end.

Drawings presented herein are for illustrative purposes only and should not be construed to limit the invention in any regard. It should be appreciated that method 200 can include one or more optional steps permitting the functionality of the method 200 is retained. In one embodiment, method 200 can be a functionality of a business process management server.

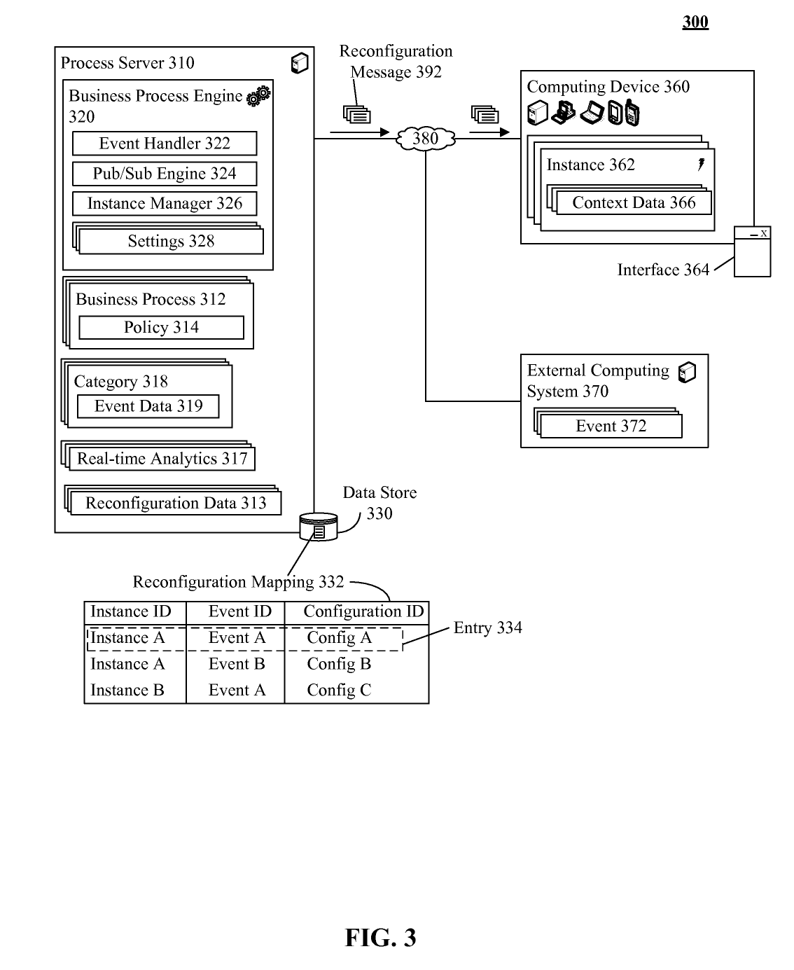

FIG. 3 is a schematic diagram illustrating a system 300 for dynamically modifying business processes based on real-time events in accordance with an embodiment of the inventive arrangements disclosed herein. System 300 can be performed in the context of flow 110, method 200, and/or embodiments 410, 430, 450. System 300 components can be communicatively linked via one or more networks 380. In system 300, a business process engine 320 can enable real-time analytics to dynamically reconfigure a business process instance.

Process server 310 can be a hardware/software entity permitting the execution of business process engine 320. Server 310 can include, but is not limited to, process engine 320, business process 312, pub/sub engine 324, real-time analytics 317, reconfiguration 313, data store 320, and the like. Server 310 functionality can include, but is not limited to, encryption, file sharing, load balancing, and the like. In one embodiment, server 310 architecture can conform to a Service Oriented Architecture (SOA). It should be appreciated that server 310 can utilize traditional and/or proprietary messaging protocols to perform the functionality described herein.

Business process engine 320 can be a hardware/software element for enabling dynamic reconfiguration of process instances 362. Engine 320 can include, but is not limited to, an event handler 322, analytics 324, instance manager 326, settings 328, and the like. Engine 320 functionality can include traditional and/or proprietary business process management capabilities. In one instance, engine 320 can be a component of a Business Process Management Server. In one embodiment, engine 320 can be a functionality of a Messaging application. In one instance, engine 320 functionality can be encapsulated with an Application Programming Interface (API).

Event handler 322 can be a hardware/software entity for event 372 management. Handler 322 functionality can include, but is not limited to, event 372 detection, event 372 analysis, data extraction, data mining, trigger configuration, and the like. In one instance, event handler 322 can permit one or more triggers to be established based on event 372 type, an event 372 data, an event 372 metadata, historical event data, and the like. In the instance, triggers can be manually and/or automatically established event 372 frequency, event 372 priority, and the like.

Pub/sub engine 324 can be a hardware/software element for performing publish/subscribe capabilities. In one embodiment, engine 324 can include a registry which can persist one or more categories 318. In the embodiment, categories 318 can be logical channels which can be associated with a subscription, a message, and the like. Pub/sub engine 324 can include event data 319, channel data, and the like. For example, event data 319 can include an event publication message data. Pub/sub engine 324 can be a functionality of a registry manager. In one instance, pub/sub engine 324 can perform traditional and/or proprietary publish/subscribe functionality (e.g., polling, message creation). For example, engine 324 can include a message queue which can distribute messages to subscribers.

Instance manager 326 can be a hardware/software entity for dynamically reconfiguring business process instances 362. Instance manager 326 functionality can include, activity creation, activity addition, activity removal, activity performance evaluation, process creation, process interruption, and the like. In one embodiment, manager 326 can determine an interruption point within instance 362. In the embodiment, interruption points can include previously defined interruption points, decision points, an activity, a sub-process, and the like. In one instance, manager 326 can be a component of a Business Process Management Server. In one embodiment, manager 326 can perform optimization on instance 362. It should be appreciated that manager 326 can support subscribe actions, unsubscribe actions, and the like.

Settings 328 can be one or more rules for configuring the behavior of system 300, server 310, and/or engine 320. Settings 328 can include, but is not limited to, handler 322 settings, analytics 324 options, instance manager 326 settings, and the like. In one instance, settings 328 can be persisted within data store 330, engine 320, device 360, and the like. In one embodiment, settings 328 can be manually and/or automatically established. In the embodiment, settings 328 can be heuristically determined from historic settings.

Business process 312 can be a collection of related, structured activities, or activities that produce a specific service or product (e.g., serve a particular goal) for a consumer. It often can be visualized with a flowchart as a sequence of activities with interleaving decision points or with a Process Matrix as a sequence of activities with relevance rules based on the data in the process. Process 312 can include management processes, operational processes, supporting processes, and the like. Processes 312 can include a policy 314 and can be associated with an instance 362. Process 312 can be decomposed into several sub-processes, which have their own attributes, but also contribute to achieving the goal of the super-process. The analysis of business processes typically includes the mapping of processes and sub-processes down to activities level. Policy 314 can include one or more rules for executing business process 312.

Analytics 317 can be one or more data sets associated with real-time analytics of event 372 occurrence. Analytics 317 can include, but is not limited to, semantic analytics, metric analytics, and the like. Analytics 317 can conform to traditional and/or proprietary analytics. In one instance, analytics 317 can include context data 366 analytics. In the instance, context data 366 can be analyzed to determine relevant instances 362 to dynamically reconfigure.

Reconfiguration data 313 can be one or more data sets for reconfiguring instance 362. Data 313 can include, but is not limited to, activity data, sub-process data, and the like. In one embodiment, data 313 can be a portion of reconfiguration message 392. In the embodiment, data 313 can be conveyed to computing device 360 which can perform reconfiguration of instance 362. It should be appreciated that reconfiguration can be performed within engine 320, device 360, and the like. In one embodiment, reconfiguration data 313 can be a portion of a configuration pool. In the embodiment, configuration pool can include previously established configuration data enabling rapid reconfiguring of an instance.

Data store 330 can be a hardware/software component able to persist mapping 332, settings 328, context data 366, analytics 317, reconfiguration data 313, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Reconfiguration mapping 332 can be one or more data sets for tracking instance modification. Mapping 332 can include, but is not limited to, an instance identifier, an event identifier, a configuration, identifier, a context data, an event data, a reconfiguration data, and the like. Mapping 332 can conform to traditional and/or proprietary mapping conventions. For example, mapping 332 can be a mapping table within a database. In one instance, mapping 332 can enable reconfiguration tracking by associating instances with reconfiguration changes. For example, entry 334 can link an instance (e.g., Instance A) with an event (e.g., Event A) which triggered a reconfiguration (e.g., Config A).

Reconfiguration message 392 can be one or more publish/subscribe messages for reconfiguring instance 362. Message 392 can conform to traditional and/or proprietary message formats. In one instance, message 392 can conform to an Extensible Markup Language (XML) format. In one embodiment, message 392 can be conveyed between communicatively linked components of engine 320, system 370, and the like. In the embodiment, message 392 can permit internal and/or external instance modification. That is, instances 362 executing within a computing system external to the server 310 can be dynamically modified utilizing system 300 functionality.

Computing device 360 can be a software/hardware element for executing instance 362, presenting analytics 317, and the like. Device 360 can include, but is not limited to, input components (e.g., keyboard), interface 372, an application, output components (e.g., display), and the like. Device 360 hardware can include, but is not limited to, a processor, a non-volatile memory, a volatile memory, a bus, and the like. Computing device 360 can include, but is not limited to, a desktop computer, a laptop computer, a mobile phone, a mobile computing device, a portable media player, a Personal Digital Assistant (PDA), and the like.

Interface 364 can be a user interactive component permitting interaction and/or presentation of instance 362, process 312, policy 314, and the like. Interface 364 can be present within the context of a Web browser application, an integrated development environment (IDE), a business process management suite, and the like. In one embodiment, interface 364 can be a screen of an Business Process Management Server. Interface 364 capabilities can include a graphical user interface (GUI), voice user interface (VUI), mixed-mode interface, and the like. In one instance, interface 364 can be communicatively linked to computing device 360.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated that engine 324 can be an optional component of engine 320. It should be appreciated that one or more components within system 300 can be optional components permitting that the disclosure functionality be retained. It should be understood that engine 320 components can be optional components providing that engine 320 functionality is maintained. It should be appreciated that one or more components of engine 320 can be combined and/or separated based on functionality, usage, and the like. System 300 can conform to a Service Oriented Architecture (SOA), Representational State Transfer (REST) architecture, and the like.

It should be appreciated that the system 300 can employ feedback components to enhance the accuracy of event detection, instance reconfiguration, and the like. For example, performance metrics can be leveraged to determine effectiveness of configuration changes on an instance (e.g., current verses historic performance). In one embodiment, the disclosure can utilize heuristics to enable the functionality described herein to continually improve.

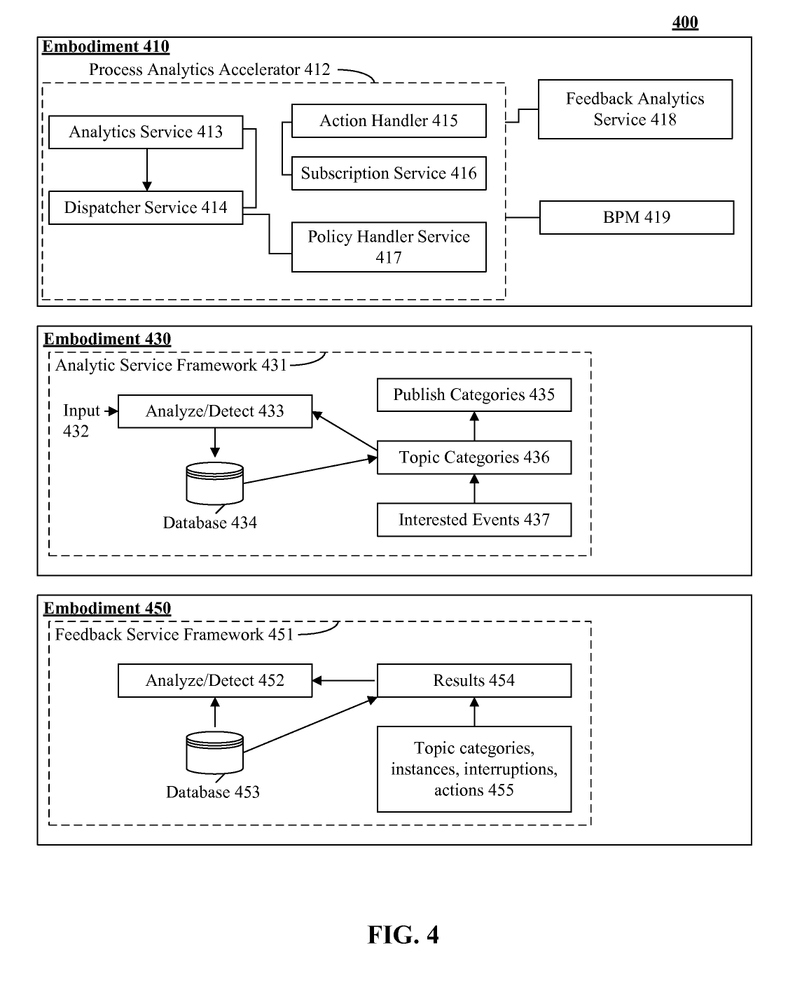

FIG. 4 is a schematic diagram illustrating a set of embodiments 410, 430, 450 for dynamically modifying business processes based on real-time events in accordance with an embodiment of the inventive arrangements disclosed herein. In embodiments 410, 430, 450, an analytics accelerator 412, analytic service framework 431, and a feedback service framework 451 can enable the functionality described herein. Embodiments 410, 430, 450 can be present in the context of flow 110, method 200, and/or system 300.

Process analytics accelerator 412 can be one embodiment of business process engine 320. Accelerator 412 can include an analytics service 413, a dispatcher service 414, an action handler 415, a subscription service 416, a policy handler 417, and the like. In one embodiment, accelerator 412 can be a component of an IBM BUSINESS PROCESS ACCELERATOR FRAMEWORK. Accelerator 412 can be communicatively linked to feedback analytics service 418 and/or a business process management 419 component. Service 413 can analyze external event data and internal business context data which can be utilized to create a topic category for ingestion. The topics categories can be published to the subscription service 416. The topic category message can include the event specifics related to business context. Analysis of activities can include simple event detection (e.g., registered non-authorized instance from criminal record management system), event patterns detection (e.g., multiple events generated from multiple data sources that is of interests), and the like.

Dispatcher service 414 can use the topic category message and based on the policies set can determine the instances of business process/sub process that are affected. The service 414 can also query a process container to determine business processes (BP) and activities which instances are executing. Once the service 414 has identified the impacted BP instances, it can signal the BPM Container to interrupt a BP instance and determine the interruption point. For example, if a business process instance is in the middle of a transaction, a roll back can be issued on the current transaction and a new activities can be inserted which can invoke the action handler (e.g. automatically create an incident record in the non-authorized incident management system and then assign a new activities to an investigator to investigate the current transaction before allowing the current transaction on continue). The dispatcher service 414 can be implemented in various ways including, as part of the process analytics engine in which case the Dispatcher service can be defined by the Process analytics engine owner or as part of the BPM container in which case the policies can be defined by the BP owners.

Service 414 can be extended with additional feedback analytics service 418. Feedback analytic service 418 can update the process context database with interruptions and actions taken. Service 414 can query the feedback service for past actions to the selected business process and send that information to action handler automatically.

Action handler service 415 can define actions to be applied to the business process. Based on the policies set, the action handler 415 can be invoked. The action can be an activity or a sub process. The action handler can generate the activities or the sub process steps (e.g., action can be creating a new case for investigator to investigate non-authorized events).

Feedback analytics service 418 can include a feedback context database to record the previous actions, business context data related to past events, interruptions, and the like. This service can be called from analytics service 413 or dispatcher service 414 components and the results can be analyzed to improve the analytics service and dispatcher service.

Embodiment 430 can include an analytics service framework 431. In one instance, framework 431 can be a portion of analytics service 413. In embodiment 430, framework 431 can include an input 432, an analyze/detect component 433, a database 434, a publish categories 435, a topic categories 436, an interested events 437, and the like. Components 433-437 can be communicatively linked via one or more computing networks, buses, and the like.

Embodiment 450 can include an analytics service framework 451. In one instance, framework 431 can be a portion of feedback analytics service 418. In embodiment 450, framework 451 can include, an analyze/detect component 452, a database 453, a results 454, and a topic categories, instances, interruptions, actions 455, and the like. Components 452, 453 can be communicatively linked via one or more computing networks, buses, and the like.

Drawings presented herein are for illustrative purposes only and should not be construed to limit the invention in any regard. It should be appreciated that embodiments 430, 450 can correspond to functionality described herein.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for dynamic business process modification comprising:
detecting an event within at least one of an external environment and an internal environment, wherein the environments is computing environment within a computing device;
performing real-time analytics to determine event specifics, wherein the event specifics is at least one of a state and a state data;
determining a published category associated with the event based on the real-time analytics performed on the event associated with the event;
publishing at least one of the category and the event specifics to a subscription registry;
responsive to the publishing, conveying a subscription message to a business process instance subscribed to the category, wherein the instance is associated with a business process, wherein the instance is comprised of at least one of an activity and a process, wherein the business process instance is a business process execution language (BPEL) entity;
interrupting the instance during execution of an activity, wherein the activity is not a fault handling activity;
identifying a change to perform on the instance, wherein the indentifying is determined from at least one of the event specifics and a configuration setting; and
automatically reconfiguring the instance based on the change.

2. The method of claim 1, further comprising:
dynamically notifying a business process instance in real-time in response to the detecting via a publish message comprising of the event specifics.

3. The method of claim 1, further comprising:
analyzing a context data associated with the instance in real-time.

4. The method of claim 1, further comprising:
correlating a business context data and the event with the analytics to refine the interruption and reconfiguration.

5. The method of claim 1, further comprising:
selecting at least one of an activity and a process to be placed into the instance to reconfigure the instance.

6. The method of claim 1, further comprising:
selecting a business process instance within a business process management environment; and
subscribing the business process instance to the published category within the registry.

7. The method of claim 1, further comprising:
responsive to the reconfiguring, performing at least one compensation action on the instance, wherein the compensation action reverses the effects of activities which were committed prior to the interrupting.

8. The method of claim 1, further comprising:
selecting a resource within a business process management environment, wherein the resource is at least one of a activity and a process; and
associating the resource with a configuration pool, wherein the configuration pool is utilized during the reconfiguring.

9. The method of claim 1, further comprising:
automatically updating at least one activity variable responsive to the reconfiguring.

10. A system for dynamic business process modification comprising:
a business process engine able to dynamically reconfigure a business process instance of a business process responsive to an event occurring within a computing environment, wherein the instance is associated with a business process, wherein the instance is comprised of at least one of an activity and a process, wherein the business process instance is a business process execution language (BPEL) entity;
a data store configured to persist at least one of a reconfiguration mapping, an event data, and a context data.

11. The system of claim 10, further comprising:
an event handler configured to perform real-time analytics on the event to determine event specifics, wherein the event specifics is at least one of a state and a state data associated with the event;
a pub/sub engine able to convey a publish message to the instance dynamically notifying the process instance in real-time comprising of the event specifics; and
an instance manager configured to correlate the event specifics with context data associated with the instance based on the publish message.

12. The system of claim 10, further comprising:
a configuration pool comprising of at least one an activity and a process, wherein the at least one of an activity and a process is dynamically generated.

13. The system of claim 12, wherein the at least one activity and process is associated with a keyword tag.

14. The system of claim 10, further comprising:
the engine responsive to a reconfiguring, performing at least one compensation action on the instance, wherein the compensation action reverses the effects of activities which were committed prior to the interrupting.

15. The system of claim 10, further comprising:
the engine, selecting a resource within a business process management environment, wherein the resource is at least one of a activity and a process; and
associating the resource with a configuration pool, wherein the configuration pool is utilized during the reconfiguring.

16. The system of claim 10, further comprising:
the engine automatically updating at least one activity variable responsive to the reconfiguring.

17. The system of claim 10, further comprising:
the engine interrupting an activity of the process instance during runtime, wherein the activity lacks a fault handling capability.

18. The system of claim 17, further comprising:
the engine, responsive to the interrupting, conveying a notification to a computing device associated with a user linked to the instance.

19. A computer program product comprising a computer readable storage medium having computer usable program code embodied therewith, the computer usable program code comprising:
computer usable program code stored in a storage medium, if said computer usable program code is executed by a processor it is operable to detect an event within at least one of an external environment and an internal environment, wherein the environments is computing environment within a computing device;
computer usable program code stored in a storage medium, if said computer usable program code is executed by a processor it is operable to perform real-time analytics to determine event specifics, wherein the event specifics is at least one of a state and a state data;
computer usable program code stored in a storage medium, if said computer usable program code is executed by a processor it is operable to determine a published category associated with the event based on the real-time analytics performed on the event associated with the event;
computer usable program code stored in a storage medium, if said computer usable program code is executed by a processor it is operable to publish at least one of the category and the event specifics to a subscription registry;
computer usable program code stored in a storage medium, if said computer usable program code is executed by a processor it is operable to convey a subscription message to a business process instance subscribed to the category, responsive to the publishing, wherein the instance is associated with a business process, wherein the instance is comprised of at least one of an activity and a process, wherein the business process instance is a business process execution language (BPEL) entity;
computer usable program code stored in a storage medium, if said computer usable program code is executed by a processor it is operable to interrupt the instance during execution of an activity, wherein the activity is not a fault handling activity;
computer usable program code stored in a storage medium, if said computer usable program code is executed by a processor it is operable to identify a change to perform on the instance, wherein the indentifying is determined from at least one of the event specifics and a configuration setting; and
computer usable program code stored in a storage medium, if said computer usable program code is executed by a processor it is operable to automatically reconfigure the instance based on the change.

20. The computer program product of claim 19, wherein the product correlates a business context data and the event with the analytics to refine the interruption and reconfiguration.
